(19) United States
(12) Patent Application Publication
(10) Pub. No.: US 2025/0173914 A1
(43) Pub. Date: May 29, 2025

(54) PRESENTATION OF MEDIA OBJECTS BY ARTIFICIAL INTELLIGENCE SYSTEMS USING VEHICLE TELEMETRY

(71) Applicant: Rivian IP Holdings, LLC, Irvine, CA (US)

(72) Inventors: Ramit Pahwa, Austin, TX (US); Abhinav Modi, Vancouver (CA); Jing Hwu, Sunnyvale, CA (US); Manali Yadunath Deshmukh, Livermore, CA (US); Anagha Kate, Milpitas, CA (US)

(73) Assignee: Rivian IP Holdings, LLC, Irvine, CA (US)

(21) Appl. No.: 18/523,225

(22) Filed: Nov. 29, 2023

(51) Int. Cl. G06T 11/00; G06F 40/40; G06N 20/00; G06T 13/00

(52) U.S. Cl. CPC G06T 11/00; G06F 40/40; G06N 20/00; G06T 13/00; G06T 2200/24

(57) ABSTRACT

Aspects of this technical solution can apply a text prompt and at least one of vehicle information, drive mode, or drive profile to a machine learning model to generate at least one of an appearance, motion, or sound of an object, and cause a user interface to present the object.

### TECHNICAL FIELD

The present implementations relate generally to electric vehicles, including but not limited to presentation of media objects by artificial intelligence systems using vehicle telemetry.

### INTRODUCTION

Users increasingly expect increased interactivity with higher levels of personalization in a wider range of interactions with the digital world. Users expect that their digital interactions will have increased relevance to their activities and preferences, including during driving or traveling. However, conventional systems lack a capability to effectively provide interactive digital experiences that are relevant to specific users, in the context of driving or traveling.

### SUMMARY

This disclosure is generally directed to animating a character (e.g., the GearGaurd Yeti) on a display screen of a vehicle or a user device (e.g., a smart phone) used to configure aspects of the vehicle. This achieves a technical improvement of quick animation for feature preview in a user interface of a vehicle (e.g., an Infotainment center), as well as to generate new visuals for the infotainment. Features of this disclosure include style transfer, animation, and chat features. Style transfer for the Yeti can apply to seasonal settings, like dressing up the Yeti in Santa Claus theme for Christmas. Animating the Yeti with audio can include animation for previewing new features and interaction with the customer. The Yeti can be presented as a chatbot using generative AI and text-to-speech software stacks. The generative AI is trained (e.g., updated) or consumes for downstream task various different types of data such as one or more of text inputted by a user (driver, passenger, and so on), vehicle information (e.g., vehicle telemetry data and other types of vehicle data), drive mode, and drive profile (of the driver or the passenger) as inputs to generate the animation to be displayed. For example, the remote system can detect consumption of media content across a fleet that satisfies a popularity threshold, and generate Yeti characters whose appearance or movement corresponds to the media content or source of the media content. Thus, a technical solution for presentation of media objects by artificial intelligence systems using vehicle telemetry is provided.

At least one aspect is directed to a system. The system can include a memory and a processor. The system can apply a text prompt and at least one of vehicle information, drive mode, or drive profile to a machine learning model to generate at least one of an appearance, motion, or sound of an object. The system can cause a user interface to present the object.

At least one aspect is directed to a system. The system can include a memory and a processor. The system can generate an output by applying to a machine learning model an input, a text prompt associated with the input, and at least one of vehicle information, drive mode, or drive profile associated with a vehicle, where the input comprises at least one of a first appearance, a first motion, or a first sound of an object, and the output comprises at least one of a second appearance, a second motion, or a second sound of the object. The system can update the machine learning model by comparing the output to the input.

At least one aspect is directed to a method. The method can include generating an output by applying to a machine learning model an input, a text prompt associated with the input, and at least one of vehicle information, drive mode, or drive profile associated with a vehicle, where the input comprises at least one of a first appearance, a first motion, or a first sound of an object, and the output comprises at least one of a second appearance, a second motion, or a second sound of the object. The method can include updating the machine learning model by comparing the output to the input.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system according to this disclosure.

FIG. 2 depicts an example AI processing architecture according to this disclosure.

FIG. 3 depicts an example theme transform architecture according to this disclosure.

FIG. 4 depicts an example texture transform architecture according to this disclosure.

FIG. 5 depicts an example motion transform architecture according to this disclosure.

FIG. 6 depicts an example vehicle user interface according to this disclosure.

FIG. 7 depicts an example method of presentation of media objects by artificial intelligence systems using vehicle telemetry according to this disclosure.

FIG. 8 depicts an example method of presentation of media objects by artificial intelligence systems using vehicle telemetry according to this disclosure.

FIG. 9 depicts an example method of presentation of media objects by artificial intelligence systems using vehicle telemetry according to this disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

This disclosure is directed at least to a system to generate one or more media content objects corresponding to given interactions with, or activities by a vehicle, and to present various ones of the media content objects in response to the given interactions with or activities by a vehicle. For example, a system according to this disclosure can include a cloud environment configured to generate media content corresponding to a “Yeti” character. The Yeti can be generated with visual features applied by a generative AI engine to a base model of the Yeti that corresponds to a “default” or “neutral” state of the Yeti before any modification are applied. The cloud environment can include an interface to receive fleet information regarding the states of one or more vehicles in a fleet, and can generate text prompts compatible with a generative AI to modify the base model of the Yeti. Fleet information can include fleet telemetry, either aggregated or linked with a given vehicle or group of vehicles. Fleet telemetry or usage can be aggregated to identify a type of usage of a vehicle. For example, a type of usage can correspond to activation of given media content or drive modes. The cloud environment can receive fleet telemetry and detect new triggers based on the type of usage.

The cloud environment can generate new animations that correspond to a trigger for the type of usage, and transmit the new animations to the vehicle fleet for presentation concurrent with the type of usage. For example, the cloud environment can detect that a number of vehicles exceeding a given popularity threshold are playing a given song by a given artist via interaction data at the user interface of the vehicle, and can generate a Yeti having a theme corresponding to attire of the artist or genre of the music. For example, the cloud environment can transmit a media object generated at the cloud environment to the vehicle for storage at the vehicle and presentation at the user interface of the vehicle. For example, the cloud environment can transmit a text prompt and an identification of a particular AI model to the vehicle for storage at the vehicle and presentation at the user interface of the vehicle. Here, the vehicle can include the AI model locally and can execute the AI model using the prompt to generate the media object. Thus, the cloud environment can transmit rendered media objects to the vehicle to provide a technical improvement to minimize the amount of computational resources expended by the vehicle to present the media object. Further, the vehicle can locally render media objects as needed based on text prompts provided by the cloud environment, to provide a technical improvement to minimize the amount of computational resources expended for transmission (e.g., cellular data or bandwidth) between the vehicle and the cloud environment.

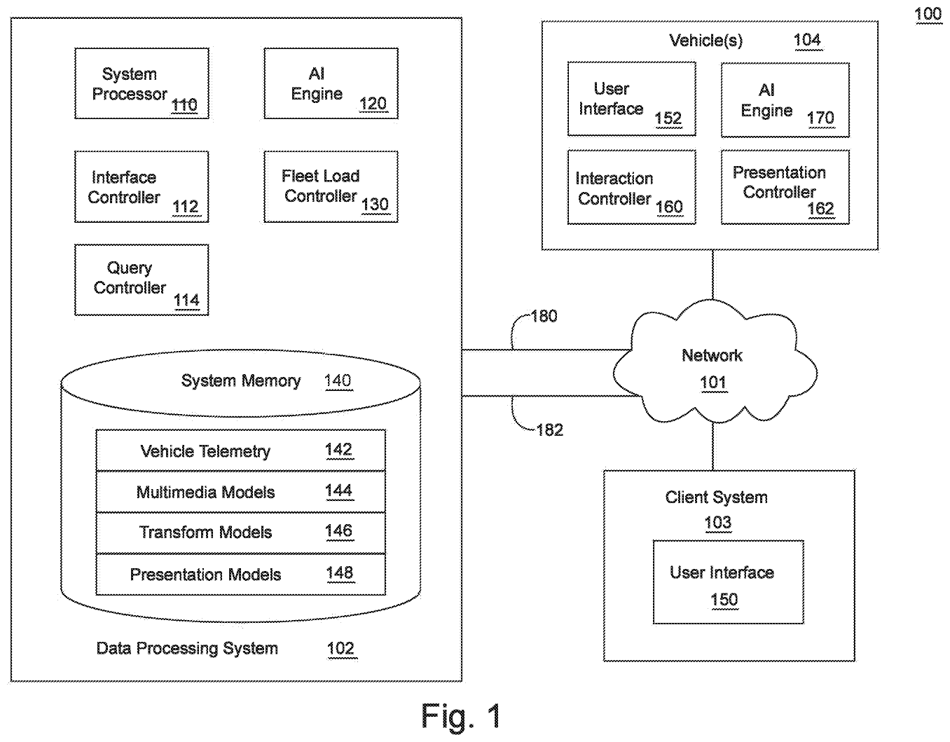

FIG. 1 depicts an example system according to this disclosure. As illustrated by way of example in FIG. 1, a system 100 can include at least a network 101, a data processing system 102, a client system 103, and a vehicle(s) 104.

The network 101 can include any type or form of network. The geographical scope of the network 101 can vary widely and the network 101 can include a body area network (BAN), a personal area network (PAN), a local-area network (LAN), e.g. Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The data processing system 102 can include a physical computer system operatively coupled or coupleable with one or more components of the system 100, either directly or directly through an intermediate computing device or system. The data processing system 102 can include a virtual computing system, an operating system, and a communication bus to effect communication and processing. The data processing system 102 can include a system processor 110, an interface controller 112, a query controller 114, an AI engine 120, a fleet load controller 130, a system memory 140, a vehicle communication channel 180, and a client communication channel 182.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controllers to effect communication between the system processor 110 and the other elements of the system 100.

The interface controller 112 can link the data processing system 102 with one or more of the network 101, the client system 103, and the vehicles 104, by one or more communication interfaces. A communication interface can include, for example, an application programming interface (“API”) compatible with a particular component of the data processing system 102, the client system 103, or the vehicles 104. The communication interface can provide a particular communication protocol compatible with a particular component of the data processing system 102 and a particular component of the client system 103 or the remote system 104. The interface controller 112 can be compatible with particular content objects, and can be compatible with particular content delivery systems corresponding to particular content objects, structures of data, types of data, or any combination thereof. For example, the interface controller 112 can be compatible with transmission of video content, audio content, or any combination thereof. For example, the interface controller 112 can format communication according to a communication protocol compatible with one or more components of the vehicle 104.

The query controller 114 can generate or modify a query compatible with the AI engine 120. The query controller 114 can generate a query in response to detecting given activity at one or more vehicles. For example, the query controller 114 can detect that a number of the vehicles 104 in a fleet or in a given geographic area are consuming multimedia content referencing a New Year holiday. The query controller 114 can generate a query including “the Yeti participating in a New Year activity” in response to the detection as discussed above. The query controller 114 can generate a query in response to detecting given activity stored at one or more storage areas of the system memory 140. For example, the query controller 114 can determine that a number of the vehicles 104 in the fleet or in the given geographic area have used a sport driving mode. The query controller 114 can generate a query including “the Yeti wearing sport-driving attire” in response to the detection discussed above.

The AI engine 120 can generate one or more multimedia objects in response to one or more inputs. The AI engine 120 can be configured to receive input including text that corresponds to an input text prompt. The input text prompt can identify a base content object and a modification operation to be performed on the based content object. For example, a based content object can correspond to the Yeti in the default state as discussed herein. For example, a modification operation can correspond to a change in visual appearance of the Yeti, in terms of one or more of clothing, color, or movement of the Yeti. The AI engine 120 can be configured to receive input including state of one or more components of one or more of the vehicles 104. For example, the AI engine 120 can receive vehicle telemetry live from one or more of the vehicles 104, or can receive vehicle telemetry from the system memory 140. The AI engine can modify or create the input including text to correspond to the vehicle telemetry or other vehicle state or activity indications. For example, the AI engine 120 can determine for vehicle telemetry related to user interfaces of the vehicle 104, that a given number of the vehicles 104 are playing content related to a given artist, and can generate a prompt including text of “the Yeti dressed as [artist]” based on the vehicle telemetry.

The AI engine 120 can generate a media object that corresponds to the base figure and the modification indicated by the input, and corresponding to vehicle telemetry or other vehicle state or activity indications. For example, the AI engine 120 can generate a Yeti modified to wear a heavy coat or a sweater in response to a determination that a sensor of the vehicle 104 detects a temperature below 40 degrees Fahrenheit. For example, the AI engine 120 can generate a Yeti modified to wear a heavy coat or a sweater in response to a determination that a cabin heating mode of the vehicle 104 is activate via input at the user interface of the vehicle 104.

The AI engine 120 can include and execute one or more AI models. For example, the AI engine 120 can include one or more instructions to cause the system processor 110 to execute an AI model. For example, the AI engine 120 can allocate one or more instructions the system processor 110 to cause the system processor 110 to execute the AI model. For example, the AI engine 120 can include one or more circuits, processors, processor cores, or any combination thereof, to execute an AI model. The AI engine 120 can include, for example, one or more instructions, circuits, or processors configured to execute a diffusion model that takes as input a text prompt, a base model, and vehicle information, and outputs a modified model as discussed herein. The AI model 120 can store a diffusion model that is configured to receive vehicle information and generate or modify a text input to include text descriptive of the vehicle information, or descriptive of a physical appearance or motion corresponding to the vehicle information. For example, the AI engine 120 can detect that a distance traveled by a vehicle exceeds a threshold indicating a long trip. The AI engine 120 can modify a text input responsive to the detecting the distance exceeding the threshold, to include a term “tired” corresponding to a long trip. The AI engine 120 or the system memory 140 can store text descriptive of or corresponding to vehicle information.

The fleet load controller 130 can control communication with one or more of the vehicles 104 and can transmit one or more media objects or text inputs to the vehicles 104. For example, the fleet load controller 130 can obtain a media object or a text input corresponding to a media object, and can transmit the media object or the text input corresponding to the media object to one or more of the vehicles 104. For example, the fleet load controller 130 can detect that a number of vehicles 104 in a first geographic region (e.g., United States) have played a song or album by a given first artist. The fleet load controller can transmit text or identifiers corresponding to the first artist, and can obtain a text prompt or a media object corresponding to the first artist, from the AI engine 120. The fleet load controller 130 can then transmit one or more of the text prompt or the media object form the first artist to one or more of the vehicles 104 in the first geographic region.

The system memory 140 can store data associated with the system 100. The system memory 140 can include one or more hardware memory devices to store binary data, digital data, or the like. The system memory 140 can include one or more electrical components, electronic components, programmable electronic components, reprogrammable electronic components, integrated circuits, semiconductor devices, flip flops, arithmetic units, or the like. The system memory 140 can include at least one of a non-volatile memory device, a solid-state memory device, a flash memory device, or a NAND memory device. The system memory 140 can include one or more addressable memory regions disposed on one or more physical memory arrays. A physical memory array can include a NAND gate array disposed on, for example, at least one of a particular semiconductor device, integrated circuit device, and printed circuit board device. The system memory 140 can include a vehicle telemetry storage 142, a multimedia model storage 144, a transform model storage 146, and a presentation model storage 148.

The vehicle telemetry storage 142 can store vehicle state information corresponding to one or more of the vehicles 104 or any components of the vehicles 104. For example, the vehicle telemetry storage 142 can store interactions at one or more of the vehicles 104, including selections via a user interface of the vehicles 104 of various media content, vehicle modes, climate controls, or any combination thereof. For example, the vehicle telemetry storage 142 can store operations of one or more of the vehicles 104, including driver operations of steering controls, driver operations of braking controls, emergency actions (e.g., anti-lock braking operations or lane assists, or any combination thereof. The vehicle telemetry storage 142 can store the vehicle information segmented by one or more vehicle fleets, geographic areas, or time periods, for example.

The multimedia model storage 144 can store one or more multimedia models generated by the AI engine 120 or obtained as input by the AI engine 120. For example, the multimedia model storage 144 can store one or more base models and can store one or more modified base models and text inputs corresponding to the base models. The multimedia model storage 144 can link one or more multimedia models with one or text inputs or vehicle input operations. For example, the multimedia model storage 144 can store an instance of the text input linked with each multimedia object, to allow the fleet load controller 130 transmit one or more of the multimedia object and the text input corresponding to the multimedia object to the vehicles 104. For example, the fleet load controller 130 can transmit an instance of a multimedia object to a first vehicle 104 upon determining that the first vehicle 104 is configured to present pre-generated media objects. For example, the fleet load controller 130 can transmit a text input corresponding to the instance of the multimedia object to a second vehicle 104 upon determining that the second vehicle 104 is configured to locally generate media objects from text inputs stored locally in that vehicle 104.

The transform model storage 146 can store one or more AI models or one or more parameters of one or more AI models. For example, the transform model storage 146 can include one or more instructions to execute a diffusion model or to configure one or more processors according to a diffusion model. The presentation model storage 148 can store one or more instructions to control presentation of one or more media objects at one or more user interfaces of one or more of the vehicles 104. For example, the presentation model storage 148 can cause a user interface to present an animation at a given speed, or present a media object at a particular position in a user interface to avoid obstruction of various control affordances or presentations of vehicle telemetry.

The vehicle communication channel 180 can include a first communication interface configured to communicate with one or more or the vehicles 104. For example, the vehicle communication channel 180 can include a first application programming interface (API) configured to transmit one or more media objects or text inputs to one or more vehicles 104 designated or selected by the fleet load controller 130. For example, the vehicle communication channel 180 can include one or more request controllers to select one or more of the vehicles 104 or one or more components of one or more of the vehicles 104. The vehicle communication channel 180 can transmit or receive information unidirectionally or bidirectionally between the data processing system 102 and one or more of the vehicle 104.

The client communication channel 182 can include a second communication interface configured to communicate with one or more or the client system 103. For example, the client communication channel 182 can include second API configured to transmit or receive information with client systems 103 linked with one or more vehicles 104. For example, the client communication channel 182 can include one or more notification controllers to transmit a notification to one or more of the vehicles 104 of a states of the vehicle 104 or one or more components of the vehicle 104 linked with the client system 103. The client communication channel 182 can transmit or receive information unidirectionally or bidirectionally between the data processing system 102 and the client system 103.

The client system 103 can include a device controlled or operated by a user linked with a vehicle among the vehicles 104 or controlled or operated by a driver of the vehicle among the vehicles 104. For example, the client system 103 can correspond to a smartphone, a tablet computer, a laptop computer, a client application configured to execute on any of the foregoing, but is not limited thereto. The client system 103 can include a user interface 150. The user interface 150 can provide one or more human-perceivable outputs, including but not limited to visual, audio, and haptic output. The user interface can, for example, be presentable on a display device operatively coupled with or integrated with the client system 103. For example, the display can be a front face of a smartphone including a capacitive touch interface. The display can display at least one or more user interface presentations and control affordances, and can include an electronic display. An electronic display can include, for example, a liquid crystal display (LCD), a light-emitting diode (LED) display, an organic light-emitting diode (OLED) display, or the like. The display device can be housed at least partially within the client system 103.

The user interface 150 can present one or more of the presentation models 148. For example, the client system 103, as a mobile device of a given user, can receive and store a presentation model of a Yeti generated by the data processing system 102. The client system 103 can present the presentation model of a Yeti in response to receiving input at the user interface 105. For example, the user can open an application at the client system 103 via the user interface 150 that is linked with the vehicle 104. The user can select a climate control option to change the temperature of the vehicle by activating an air conditioning device of the vehicle 104. In response, the user interface 150 can present a presentation model of a Yeti wearing winter clothing experiencing a cold wind. The user interface can present a presentation model in response to a user action at a different client system 103. For example, a user at a second mobile device can open an application that is linked with the vehicle 105 (e.g., multiple family members who are connected to the same vehicle by applications on individual mobile devices of each family member). For example, in response to the selection by a first user of a first application at a first mobile device of a climate control option to change the temperature of the vehicle by activating an air conditioning device of the vehicle 104, a second application of a second mobile device of a second user can display the presentation model of the Yeti wearing winter clothing experiencing the cold wind.

The vehicle(s) 104 can include one or more automobiles. For example, a vehicle can be an electric vehicle. The vehicle(s) 104 can correspond to one or more vehicles 104 in a given geographic area, jurisdictions, geofence, or any combination thereof, for example. The vehicle(s) 104 can correspond to one or more vehicles 104 associated with a fleet, owner, operation, or any combination thereof, for example. For example, the vehicle(s) 104 can include a plurality of vehicles grouped into a United States fleet, a Canada fleet, and a United Kingdom fleet. For example, the vehicle(s) 104 can include a plurality of vehicles grouped into an individually-owned fleet, a first fleet operated by a first operator company, and a second fleet operated by a second operator company. Each of the vehicles can be associated with zero or more fleets. The vehicle(s) 104 can each include a user interface 152, an interaction controller 160, a presentation controller 162, and an AI engine 170.

The user interface 152 can provide one or more human-perceivable outputs, including but not limited to visual, audio, and haptic output, at a given vehicle 104 among the vehicles 104. The user interface 152 can, for example, be presentable on a display device operatively coupled with or integrated with the given vehicle 104. For example, the display can be integrated with a dashboard of the given vehicle 104. The display can display at least one or more user interface presentations and control affordances, and can include an electronic display. An electronic display can include, for example, a liquid crystal display (LCD), a light-emitting diode (LED) display, an organic light-emitting diode (OLED) display, or the like. The display device can be housed at least partially within a cabin of the given vehicle 104.

The interaction controller 160 can detect input from one or more components of the given vehicle 104 and can transmit data corresponding to the one or more components to the data processing system 102. The interaction controller 160 can transmit the data by an API configured to communicate via the vehicle communication channel 180 with the data processing system 102. The interaction controller 160 can include or be linked with a vehicle data bus configured to transmit and receive data from one or more components of the vehicle. For example, the vehicle data bus can be coupled with the user interface 152 of the given vehicle 104, and can communicate with one or more of the user interface 152 and components for operating the vehicle. For example, components for operating the vehicle can include a steering wheel, pedals, door handles, door sensors, tire pressure sensors, angular displacement sensors, lateral displacement sensors, temperature sensors, speedometer, odometer, mechanical resistance, or any combination thereof, but are not limited thereto. For example, the interaction controller 160 can detect movement of a vehicle at a given speed or resistance of a shock absorber at a particular tension. The interaction controller 160 can determine, based on input from the one or more components, a state of the vehicle 104, and can transmit the state to the data processing system 102. For example, the interaction controller 160 can determine that the vehicle 104 is in a sport mode based on detection of a state from a microcontroller or bus controller of the vehicle 104, or the detected tension of the shock absorbers of the vehicle 104.

The user interface 152 can present one or more of the presentation models 148. For example, the client system 103, as a mobile device of a given user, can transmit to the vehicle 105 a presentation model of a Yeti generated by the data processing system 102. For example, the client system 103, as a mobile device of a given user, can cause the vehicle 105 to present a presentation model of a Yeti generated by the data processing system 102. The user interface 152 of the vehicle 105 can present the presentation model of a Yeti in response to receiving input at the user interface 105. For example, the user can open an application at the client system 103 via the user interface 150 that is linked with the vehicle 104. The user can select a climate control option to change the temperature of the vehicle by activating an air conditioning device of the vehicle 104. The client system 103 can, via a geolocation or near-field communication, for example, determine a distance to the vehicle 105. The client system 103 can, via Internet or near-field communication, for example, determine that the user of the client system 103 has actuated a door of the vehicle 105. The client system 103 or the data processing system 105 can determine that the user is attempting to enter the vehicle 105. In response, the user interface 152 can present a presentation model of a Yeti wearing winter clothing experiencing a cold wind, that corresponds to or matches at least partially the presentation model of the Yeti presented at the user interface 150 of the client system 103 of the user attempting to enter the vehicle 105. The user interface 152 can present a presentation model in response to a user action at a different vehicle 105.

The presentation controller 162 can provide instructions to cause the user interface 152 to generate output or receive input according to one or more types of input and output. For example, the presentation controller 162 can provide instructions to cause the user interface 152 to present a graphical user interface via a display located at a dashboard of the given vehicle 104. For example, the presentation controller 162 can provide instructions to cause the user interface 152 to receive input from a graphical user interface via a capacitive input sensor on a display located at a dashboard of the given vehicle 104. For example, the presentation controller 162 can provide instructions to cause the user interface 152 to output audio via a speaker located in a cabin of the given vehicle 104. For example, the presentation controller 162 can provide instructions to cause the user interface 152 to receive input audio via a microphone located in a cabin of the given vehicle 104. The AI engine 170 can correspond at least partially in one or more of structure and operation to the AI engine 120. For example, a given vehicle 104 among the vehicles 104 can include the AI engine 170 to execute a transform on a base figure stored at the given vehicle 104 according to a text input stored at the given vehicle 104 as discussed herein.

For example, the system can cause the user interface to present the object according to a selection of at least one of the vehicle information, the drive mode, or the drive profile at the user interface. For example, the system can generate at least one of the appearance, the motion, or the sound of the object having a property generated based on at least one of the vehicle information, the drive mode, or the drive profile. For example, the system can determine the text prompt according to a link between the text prompt and at least one of the vehicle information, the drive mode, or the drive profile. For example, the system can determine the text prompt according to at least a portion of the text prompt that is indicative of at least one of the vehicle information, the drive mode, or the drive profile. For example, the system can transmit at least one of the appearance, the motion, or the sound of the object to a vehicle can include the user interface according to a selection of at least one of the vehicle information, the drive mode, or the drive profile at the user interface. The system can include the processor. The system can apply the text prompt and at least one of the vehicle information, the drive mode, or the drive profile to the machine learning model according to a selection of at least one of the vehicle information, the drive mode, or the drive profile at the user interface.

For example, the system can include the machine learning model corresponding to a diffusion model to generate at least one of the second appearance, the second motion, or the second sound of the object. For example, the system can obtain, from one or more vehicles corresponding to the vehicle, one or more selections of at least one of the vehicle information, the drive mode, or the drive profile. For example, the system can generate the output according the one or more selections satisfying a threshold of selection corresponding to the one or more vehicles. For example, the system can generate the text prompt according the one or more selections satisfying a threshold of selection corresponding to the one or more vehicles. For example, the system can include the text prompt having a portion corresponding to text indicative of at least one of the second appearance, the second motion, or the second sound of the object. For example, the system can include the text prompt having a portion corresponding to text indicative of at least one of the vehicle information, the drive mode, or the drive profile associated with the vehicle.

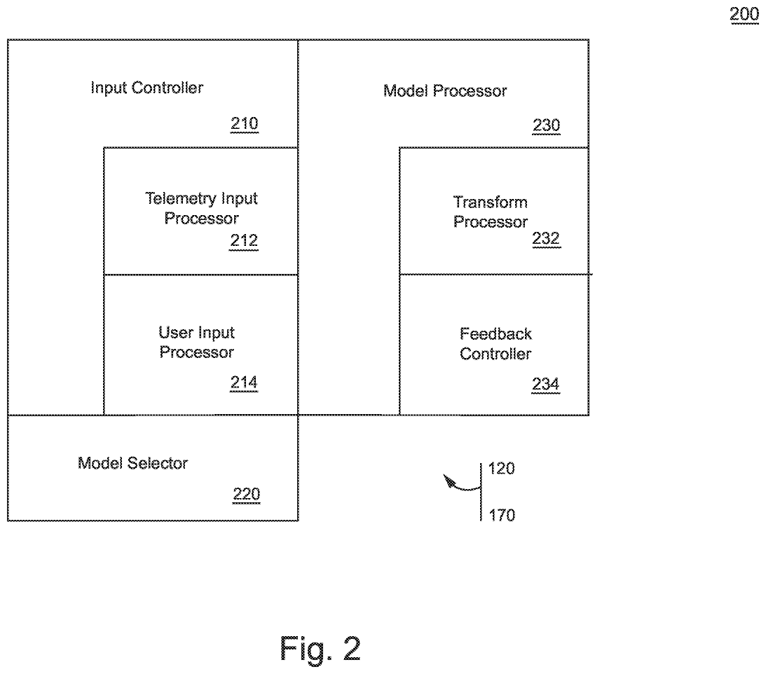

FIG. 2 depicts an example AI processing architecture according to this disclosure. As illustrated by way of example in FIG. 2, an AI processing architecture 200 can include at least an input controller 210, a model selector 220, and a model processor 230. For example, the AI processing architecture 200 can include one or more circuits, processors, or processor cores structured to execute one or more instructions according to an AI configuration or architecture. The AI engine 120 or the AI engine 170 can have the AI processing architecture 200.

The input controller 210 can detect input at one or more components of a given vehicle 104 or a plurality of vehicles 104. The input controller 210 can include a telemetry input processor 212, and a user input processor 214. The telemetry input processor 212 can detect a state of the vehicle linked with one or more components of a given vehicle 104. For example, the state of the vehicle linked with one or more components can be a sport mode, chill mode, or eco mode. For example, the eco mode can be linked with a response to change a theme of a base figure to an outdoor theme. The telemetry input processor 212 can aggregate input across a plurality of the vehicles 104 to detect state of one or more vehicle that exceeds a threshold corresponding to a given fleet of the vehicles 104.

The user input processor 214 can detect a state of the vehicle linked with input at a user interface 152. For example, the state of the vehicle linked with input at the user interface 152 motion response can be a touch input at the user interface to select a given control affordance. For example, the touch input at the user interface to select a given control affordance can be linked with a response to animate a base figure. The user input processor 214 can aggregate input across a plurality of the vehicles 104 to detect user input at one or more vehicle that exceeds a threshold corresponding to a given fleet of the vehicles 104. For example, the user input processor 214 can have a playback threshold corresponding to a number of interactions at user interface 152 of various vehicles 104 in a United States fleet. The user input processor can detect that a number of the vehicles 104 in the United States fleet that have played a particular album in a predetermined time period (e.g., last 7 days, or last 30 days), exceeds the playback threshold. Thus, the user input processor 214 can provide a technical improvement to provide granular and contemporaneous detection of vehicle events for vehicles sharing common properties as organized by fleet grouping.

The model selector 220 can select an AI configuration among the plurality AI configurations, according to input provided to one or more of the vehicles 104. The model selector 220 can select a model among the plurality of models, according to input provided to one or more of the vehicles 104. For example, the model selector 220 can select a diffusion model configured to generate a moving image from a still image, in response to the user input processor 214 detecting a state of the vehicle linked with a motion response. Thus, the model selector 220 can provide a technical solution to operate one or more AI configurations or architectures according to one or more states of one or more of the vehicles 104 or one or more components thereof.

The model processor 230 can execute one or more instructions according to an AI configuration or architecture. For example, model processor 230 can include a circuit to execute a diffusion model, a neural network model, a natural language model, a large language model, or any combination thereof. For example, the model processor 230 can include a plurality of AI configurations. The model processor 230 can provide a base figure or base image, text input corresponding to the base figure or base image, vehicle information, vehicle telemetry, or any combination thereof, to the transform processor 232. The model processor 230 can include a transform processor 232, and a feedback controller 234.

The transform processor 232 can generate an output according to the AI configuration or architecture. For example, the transform processor 232 can include instructions to modify a base image by a diffusion model according to a theme provided as text input to the model. For example, the transform processor 232 can include instructions to modify a base image by a diffusion model according to a texture provided as text input to the model. For example, the transform processor 232 can include instructions to modify a base image by a diffusion model according to a motion identifier provided as text input to the model. The feedback controller 234 can provide at least a portion of the output from the transform processor 232 to the transform processor 232 as input. Thus, the feedback controller 234 can provide a channel to execute updating, training, or retraining of any model of the model processor 230 via feedback of output by the transform processor 232.

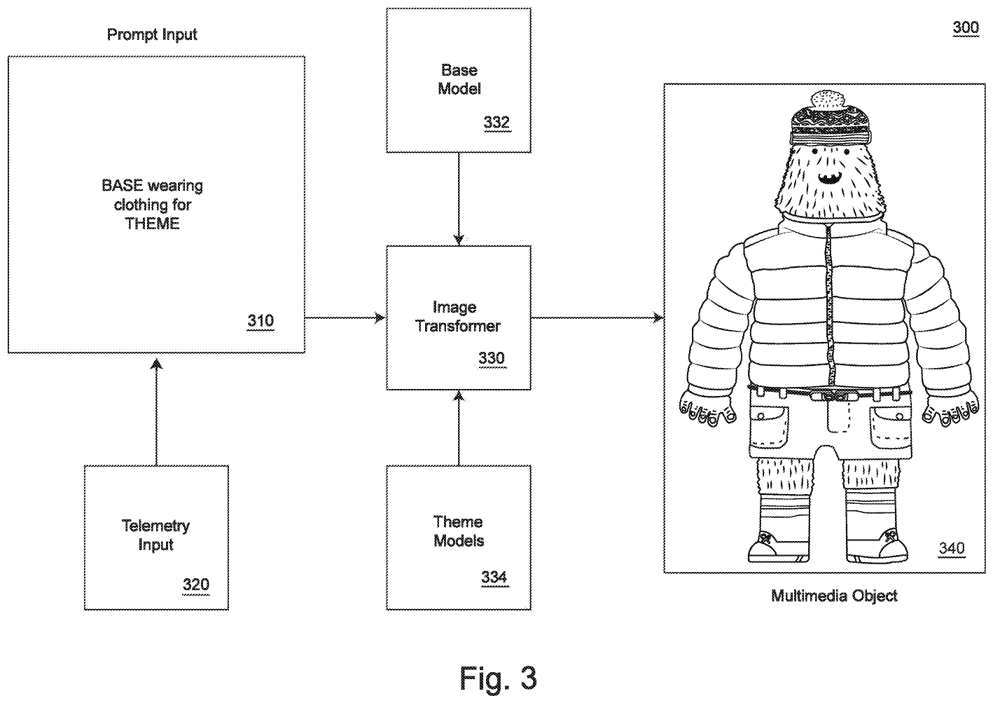

FIG. 3 depicts an example theme transform architecture according to this disclosure. As illustrated by way of example in FIG. 3, a theme transform architecture 300 can include at least a prompt input affordance 310, a telemetry channel 320, an image transformer processor 330, a theme model channel 334, and a multimedia object output 340.

The prompt input affordance 310 can receive text input. For example, the prompt input affordance 310 can include a database query processor to obtain text inputs from the multimedia models 144. For example, the prompt input affordance 310 can include a communication bus to obtain text inputs from the query controller 114. For example, a text input can include text describing “Yeti wearing clothing for winter holidays,” where “Yeti” indicates a base figure, “winter holidays” indicates a theme, and “wearing clothing for” indicates a diffusion model transform instruction. The telemetry channel 320 can receive vehicle input. For example, the telemetry channel 320 can include a database query processor to obtain vehicle telemetry from the vehicle telemetry storage 142. For example, the telemetry channel 320 can include a communication bus to obtain vehicle telemetry from the fleet load controller 130.

The image transformer processor 330 can correspond at least partially in one or more of structure and operation to the AI engine 120 or 170. The image transformer processor 330 can be coupled with a base model channel 332, and a theme model channel 334. The base model channel 332 can include a communication channel to transmit a base figure or base image, for example, to the image transformer 330. The theme model channel 334 can include a communication channel to transmit a theme model, for example, to the image transformer 330. For example, a theme model can correspond to a transform model executable by the diffusion model to modify a base figure according to a given theme or type of theme. For example, the theme model can correspond to a configuration of the diffusion model to cause the diffusion model to converge toward an image having a theme corresponding to the theme model. The theme model channel 334 can obtain the theme from the transform model storage 146. The multimedia object output 340 can provide a multimedia object corresponding to the base figure and at least one of the telemetry input 320 and the theme model received via the theme model channel 334. For example, the multimedia object output 340 can be an image file of Yeti dressed in a winter hat and winter coat.

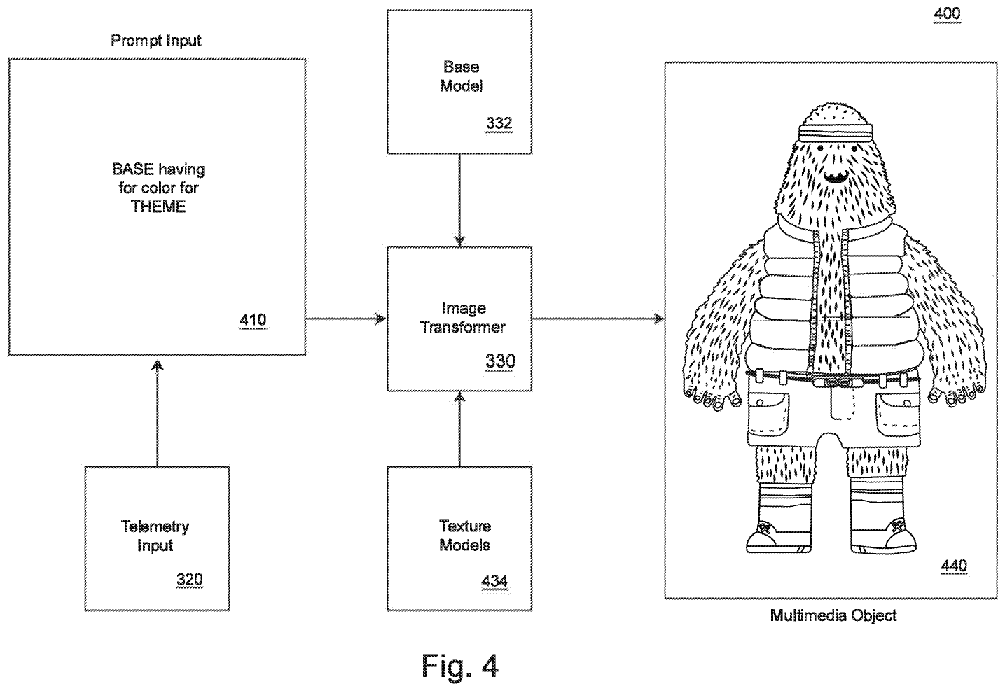

FIG. 4 depicts an example texture transform architecture according to this disclosure. As illustrated by way of example in FIG. 4, a texture transform architecture 400 can include at least the telemetry channel 320, the image transformer processor 330, the base model channel 332, a prompt input affordance 410, a texture model channel 434, and a multimedia object output 440. The prompt input affordance 410 can correspond at least partially in one or more of structure and operation to the prompt input affordance 310. For example, a text input can include text describing “Yeti having shaggy fur,” where “Yeti” indicates a base figure, “shaggy” indicates a texture, and “fur” indicates a diffusion model transform instruction. The texture model channel 434 can include a communication channel to transmit a texture model, for example, to the image transformer 330. For example, a texture model can correspond to a transform model executable by the diffusion model to modify a base figure according to a given texture or type of texture. For example, the texture model can correspond to a configuration of the diffusion model to cause the diffusion model to converge toward an image having a texture corresponding to the texture model. The texture model channel 434 can obtain the texture from the transform model storage 146. The multimedia object output 430 can provide a multimedia object corresponding to the base figure and at least one of the telemetry input 320 and the texture model received via the texture model channel 434. For example, the multimedia object output 430 can be an image file of Yeti dressed in a vest and having thicker fur than fur of the base figure Yeti.

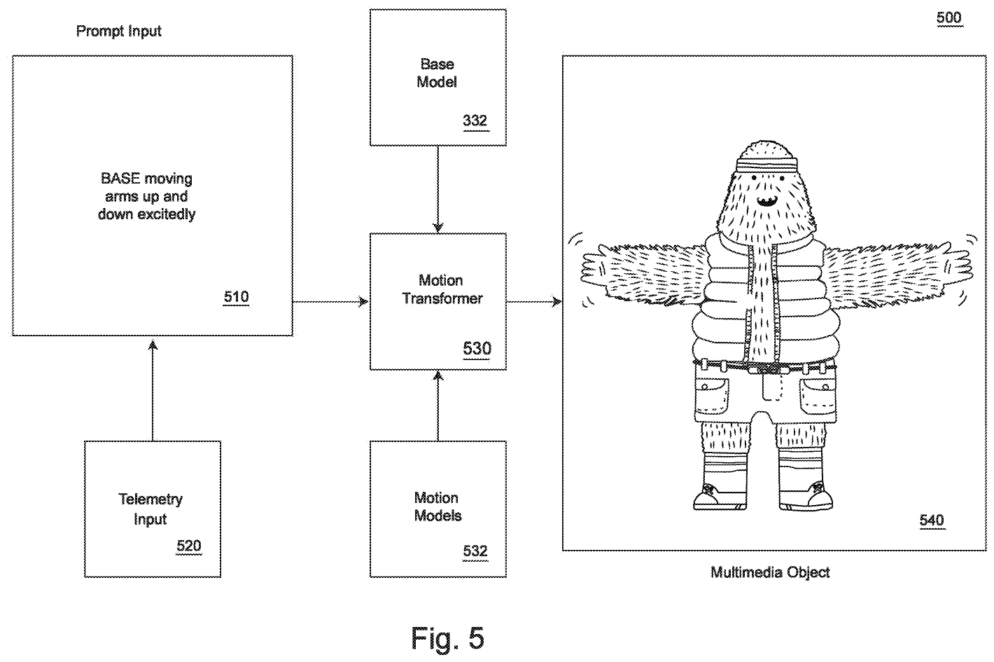

FIG. 5 depicts an example motion transform architecture according to this disclosure. As illustrated by way of example in FIG. 5, a motion transform architecture 500 can include at least the base model channel 332, a prompt input affordance 510, a telemetry channel 520, a motion transform processor 530, and a multimedia object output 540.

The prompt input affordance 510 can correspond at least partially in one or more of structure and operation to the prompt input affordance 310. For example, a text input can include text describing “Yeti moving arms up and down excitedly,” where “Yeti” indicates a base figure, “arms up and down excitedly” indicates a motion, and “moving” indicates a diffusion model transform instruction.

The telemetry channel 520 can correspond at least partially in one or more of structure and operation to the telemetry channel 320. The query controller 114 can generate the text input and transfer the text input to the prompt input affordance 510. For example, the telemetry channel 520 can indicate a change of vehicle state of a given vehicle 104 from “eco” to “sport.” For example, the telemetry channel 520 can indicate a change of vehicle state of a given vehicle 104 from “drive” to “park.” The query controller 114 can determine that the change in state is associated with a motion action or an arm-waving action according to a link or identifier stored at the vehicle telemetry storage 142. Thus, the telemetry channel 520 can provide a technical improvement to provide vehicle information as input to generate text prompts that can be executed by an AI model, including but not limited to a diffusion model.

The motion transform processor 530 can correspond at least partially in one or more of structure and operation to the image transformer processor 330. The motion transform processor 530 can be coupled with a motion model channel 532. The motion model channel 532 can include a communication channel to transmit a motion model, for example, to the motion transformer 530. For example, a motion model can correspond to a transform model executable by the diffusion model to deform at least a portion of a base figure according to a given motion or type of motion. For example, the texture model can correspond to a configuration of the diffusion model to cause the diffusion model to converge toward a video in which a limb of the base figure moves corresponding to the motion model. The motion model channel 532 can obtain the motion from the transform model storage 146. The multimedia object output 540 can provide a multimedia object corresponding to the base figure and at least one of the telemetry input 520 and the motion model received via the motion model channel 532. For example, the multimedia object output 540 can be video file of Yeti dressed in a vest and raising and lowering its arms.

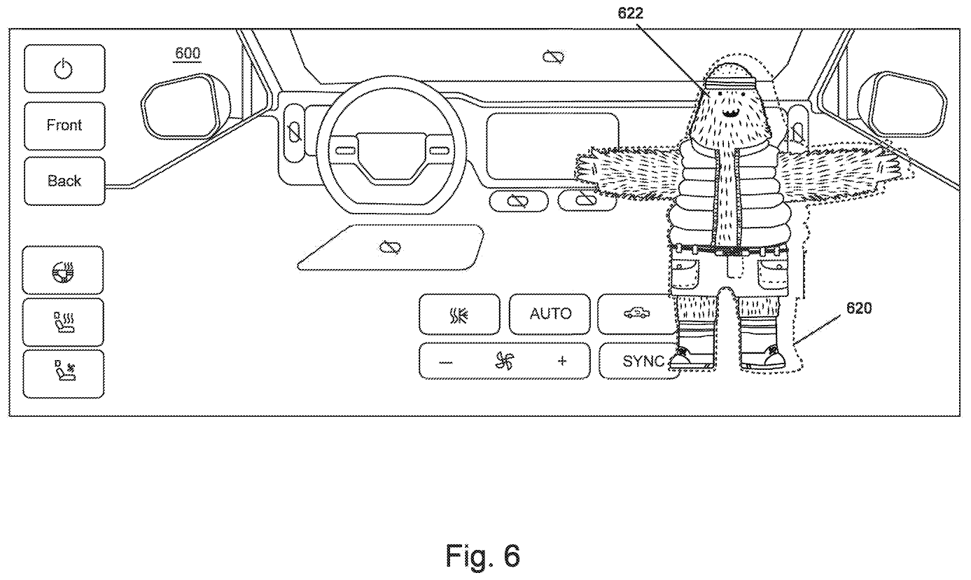

FIG. 6 depicts an example vehicle user interface according to this disclosure. As illustrated by way of example in FIG. 6, a vehicle user interface 600 can include at least a control affordance presentation region 610, and a multimedia object presentation region 620. For example, a touch screen display at the dashboard of the given vehicle 104 can present the user interface 600.

The control affordance presentation region 610 can present one or more control affordances to modify operation of the given vehicle 104 or a component thereof. For example, the control affordance presentation region 610 can include various climate control, multimedia control, and driving control affordances, that can respectively be activated by touch input. The control affordance presentation region 610 can include an activated control affordance 612. The activated control affordance 612 can correspond at least partially in one or more of structure and operation to any of the control affordances of the control affordance presentation region 610.

The multimedia object presentation region 620 can correspond to a portion of the user interface 600 that is distinct from the control affordance presentation region 610. The multimedia object presentation region 620 can include a multimedia object presentation 622. The multimedia object presentation 622 can correspond at least partially in one or more of structure and operation to the multimedia object output 340, 430 or 540. For example, the presentation controller 162 can instruct the user interface 152 to present the multimedia object output 340 at least partially in the multimedia object presentation region 620, to eliminate or mitigate obfuscation of the control affordance presentation region 610 and the control affordances presented therein.

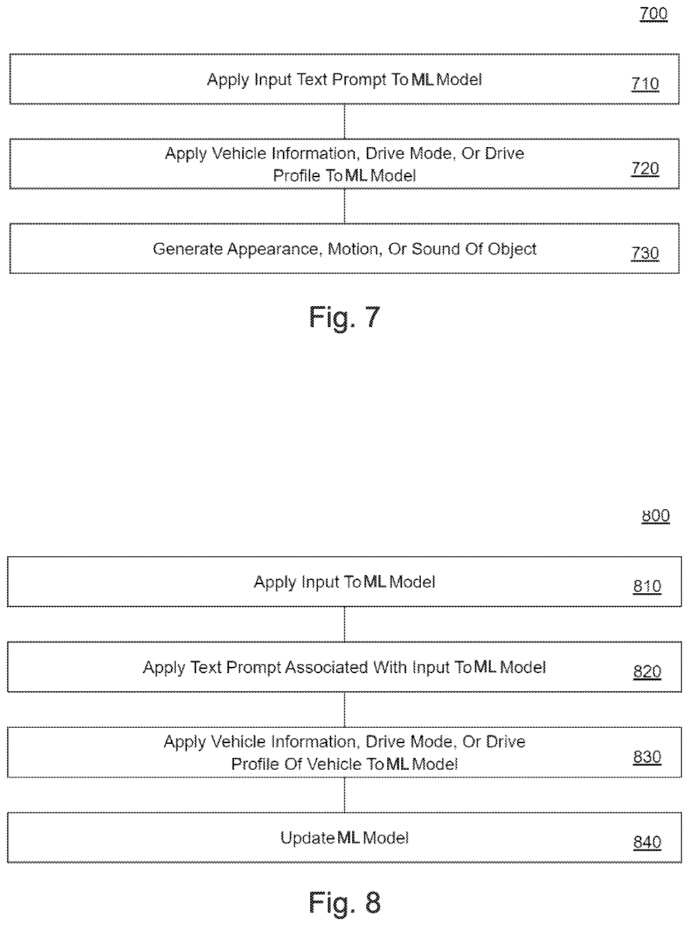

FIG. 7 depicts an example method 700 of presentation of media objects by artificial intelligence systems using vehicle telemetry according to this disclosure. At least one of the data processing system 102, the AI engine 120, or the AI engine 170 can perform the method 700.

The method 700 can apply an input a text prompt to an ML model. (Act 710.) For example, the method 700 can apply an input a text prompt to an ML model. For example, the method 700 can apply a text prompt and at least one of vehicle information, drive mode, or drive profile to a machine learning model to generate at least one of an appearance, motion, or sound of an object. For example, a drive profile can correspond to a configuration of cone or more components of a given vehicle 104 that is linked to a given user or a given driver. For example, the method can include the machine learning model corresponding to a diffusion model to generate at least one of the second appearance, the second motion, or the second sound of the object.

The method 700 can apply vehicle information, drive mode, or drive profile to the ML model. (Act 720.) For example, the method 700 can apply vehicle information, drive mode, or drive profile to the ML model. The method 700 can generate an appearance, motion, or sound of an object. (Act 730.) For example, the method 700 can generate an appearance, motion, or sound of an object. For example, the method 700 can cause a user interface to present the object. For example, the method can obtain, from one or more vehicles corresponding to the vehicle, one or more selections of at least one of the vehicle information, the drive mode, or the drive profile. For example, the method can generate the output according the one or more selections satisfying a threshold of selection corresponding to the one or more vehicles. For example, the method can generate the text prompt according the one or more selections satisfying a threshold of selection corresponding to the one or more vehicles.

FIG. 8 depicts an example method of presentation of media objects by artificial intelligence systems using vehicle telemetry according to this disclosure. At least one of the system 100 or the AI engine 170 can perform method 800.

The method 800 can apply an input to an ML model. (Act 810.) For example, the method 800 can apply an input to an ML model. For example, the query controller 114 can apply a text input based on vehicle telemetry to the AI engine 120 or 170. For example, the method can include the machine learning model corresponding to a diffusion model to generate at least one of the second appearance, the second motion, or the second sound of the object.

The method 800 can apply a text prompt associated with the input to the ML model. (Act 820.) For example, the method 800 can apply a text prompt associated with the input to the ML model. For example, the query controller 114 can apply a text input to the AI engine 120 or 170.

The method 800 can apply vehicle information, drive mode, or drive profile of a vehicle to the ML model. (Act 830.) For example, the method 800 can apply vehicle information, drive mode, or drive profile of a vehicle to the ML model. For example, the query controller 114 can apply a text input based on telemetry stored at the vehicle telemetry storage 142 to the AI engine 120 or 170. For example, the method can obtain, from one or more vehicles corresponding to the vehicle, one or more selections of at least one of the vehicle information, the drive mode, or the drive profile. For example, the method can generate the output according the one or more selections satisfying a threshold of selection corresponding to the one or more vehicles. For example, the method can generate the text prompt according the one or more selections satisfying a threshold of selection corresponding to the one or more vehicles.

The method 800 can update the ML model. (Act 840.) For example, the method 800 can update the ML model. For example, updating the ML model can correspond to training or retraining the ML model according to a feedback, loss, or the like, with respect to the ML model. For example, updating the model can include training feedback provided by user input regarding accuracy of modification of the Yeti object with a theme or other transformation. For example, a plurality of diffusion models can generate a plurality of outputs each configured to modify the Yeti to have the theme, according to the image transformer 330. Each of the plurality of diffusion models can apply a distinct theme model among the theme models 334, where each theme model has a different configuration for converging toward a given output. The data processing system 102 can generate a user interface 150 at a client system 103 to obtain an annotation of each output generated according to each theme model. For example, a user acting an as evaluator of accuracy or desirability of an output can annotation an output or a plurality of outputs with an affirmative annotation (e.g., tapping a “thumbs up” icon on the user interface 150) or a negative annotation (e.g., tapping a “thumbs down” icon on the user interface 150). Based on the feedback or an aggregate of feedback from a plurality of evaluators via a plurality of the user interfaces 150, the data processing system 102 can update one or more of the theme models to include parameters, features, or transform operations associated with the affirmative annotations and to exclude parameters, features, or transform operations associated with the negative annotations. The updating as discussed above is not limited to theme models, and can be applied to any transform model or combination of transforms models discussed herein.

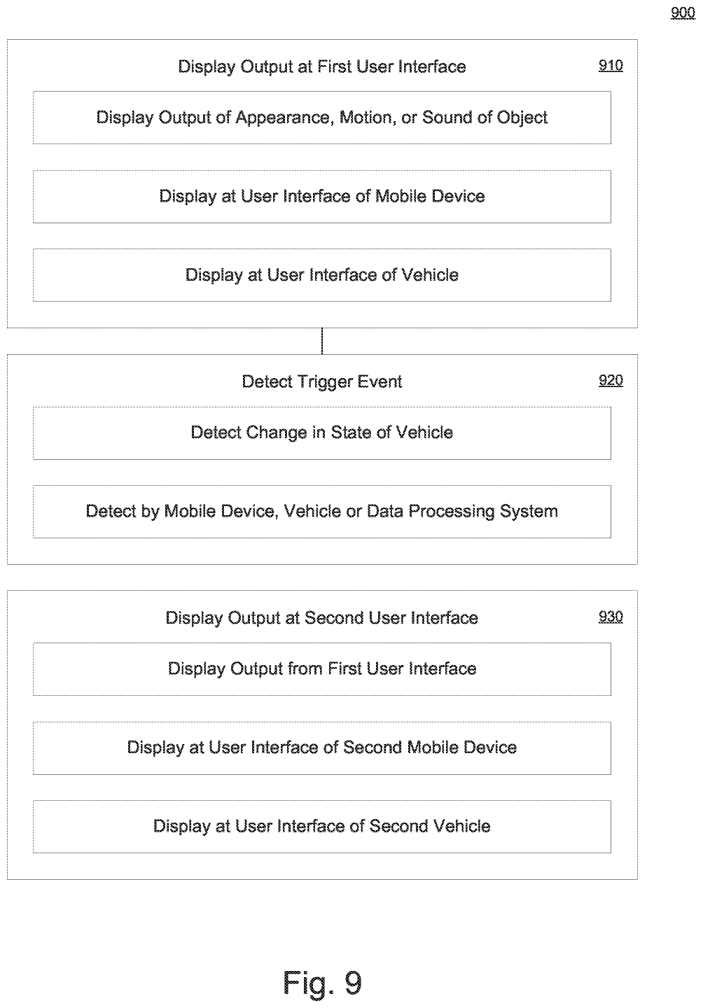

FIG. 9 depicts an example method of presentation of media objects by artificial intelligence systems using vehicle telemetry according to this disclosure. At least one of the system 100 or the AI engine 170 can perform method 900.

The method 900 can display an output at a first user interface. (Act 910.) For example, the method 900 can include displaying, at a first user interface of a first system, an output that comprises at least one of an appearance, a motion, or a sound of an object. For example, a first user interface is a touchscreen or mobile application of a mobile device according of the client system 103. For example, a first system is a mobile device of a user. For example, a first user interface is a touchscreen or control application of the vehicle 105. For example, the first system is the vehicle 105.

The method 900 can detect a trigger event. (Act 920.) For example, the method 900 can include detecting a trigger event that indicates a change in state of the second system. For example, the method 900 detect a door-opening event at the vehicle 501 by a near field communication or Internet communication interface of a mobile device according to the client system 103. For example, at least one of the data processing system 102, the client system 103, or the vehicle 105 can detect the trigger event.

The method 900 can display the output at a second user interface. (Act 930.) For example, the method 900 can include displaying the output at a second user interface of a second system, in response to the detecting a trigger event that indicates a change in state of the second system. For example, a second user interface is a touchscreen or mobile application of a mobile device according of the client system 103. For example, a second system is a mobile device of a user. For example, a second user interface is a touchscreen or control application of the vehicle 105. For example, the second system is the vehicle 105. The second user can be a distinct user interface from the first user interface. For example, the first user interface is a user interface of a mobile device, and the second user interface is a user interface of a vehicle. For example, the first user interface is a user interface of a first mobile device, and the second user interface is a user interface of a second mobile device. For example, the first user interface is a user interface of a first vehicle device, and the second user interface is a user interface of a second vehicle. For example, the first user interface is a user interface of a vehicle, and the second user interface is a user interface of a mobile device. Thus, the method 900 can trigger display of output between user interface of any device or vehicle based on a trigger event.

For example, the method can include the text prompt having a first portion and a second portion, the first portion corresponding to first text indicative of at least one of the second appearance, the second motion, or the second sound of the object, and the second portion corresponding to second text indicative of at least one of the vehicle information, the drive mode, or the drive profile associated with the vehicle.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are”, may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A system, comprising:
a memory and a processor to:
apply a text prompt and at least one of vehicle information, drive mode, or drive profile to a machine learning model to generate at least one of an appearance, motion, or sound of an object; and
cause a user interface to present the object.

2. The system of claim 1, comprising:
the processor to:
cause the user interface to present the object according to a selection of at least one of the vehicle information, the drive mode, or the drive profile at the user interface.

3. The system of claim 1, comprising:
the processor to:
generate at least one of the appearance, the motion, or the sound of the object having a property generated based on at least one of the vehicle information, the drive mode, or the drive profile.

4. The system of claim 1, comprising:
the processor to:
determine the text prompt according to a link between the text prompt and at least one of the vehicle information, the drive mode, or the drive profile.

5. The system of claim 1, comprising:
the processor to:
determine the text prompt according to at least a portion of the text prompt that is indicative of at least one of the vehicle information, the drive mode, or the drive profile.

6. The system of claim 1, comprising:
the processor to:
transmit at least one of the appearance, the motion, or the sound of the object to a vehicle including the user interface according to a selection of at least one of the vehicle information, the drive mode, or the drive profile at the user interface.

7. The system of claim 1, comprising:
the processor to:
apply the text prompt and at least one of the vehicle information, the drive mode,
or the drive profile to the machine learning model according to a selection of at least one of the vehicle information, the drive mode, or the drive profile at the user interface.

8. A system, comprising:
a memory and a processor to:
generate an output by applying to a machine learning model an input, a text prompt associated with the input, and at least one of vehicle information, drive mode, or drive profile associated with a vehicle, wherein the input comprises at least one of a first appearance, a first motion, or a first sound of an object, and the output comprises at least one of a second appearance, a second motion, or a second sound of the object; and
update the machine learning model by comparing the output to the input.

9. The system of claim 8, comprising:
the machine learning model corresponding to a diffusion model to generate at least one of the second appearance, the second motion, or the second sound of the object.

10. The system of claim 8, comprising:
the processor to:
obtain, from one or more vehicles corresponding to the vehicle, one or more selections of at least one of the vehicle information, the drive mode, or the drive profile.

11. The system of claim 10, comprising:
the processor to:
generate the output according to the one or more selections satisfying a threshold of selection corresponding to the one or more vehicles.

12. The system of claim 10, comprising:
the processor to:
generate the text prompt according to the one or more selections satisfying a threshold of selection corresponding to the one or more vehicles.

13. The system of claim 8, comprising:
the text prompt having a portion corresponding to text indicative of at least one of the second appearance, the second motion, or the second sound of the object.

14. The system of claim 8, comprising:
the text prompt having a portion corresponding to text indicative of at least one of the vehicle information, the drive mode, or the drive profile associated with the vehicle.

15. A method, comprising:
generating an output by applying to a machine learning model an input, a text prompt associated with the input, and at least one of vehicle information, drive mode, or drive profile associated with a vehicle, wherein the input comprises at least one of a first appearance, a first motion, or a first sound of an object, and the output comprises at least one of a second appearance, a second motion, or a second sound of the object; and
updating the machine learning model by comparing the output to the input.

16. The method of claim 15, comprising:
the machine learning model corresponding to a diffusion model to generate at least one of the second appearance, the second motion, or the second sound of the object.

17. The method of claim 15, comprising:
the processor to:
obtain, from one or more vehicles corresponding to the vehicle, one or more selections of at least one of the vehicle information, the drive mode, or the drive profile.

18. The method of claim 17, comprising:
the processor to:
generate the output according the one or more selections satisfying a threshold of selection corresponding to the one or more vehicles.

19. The method of claim 17, comprising:
the processor to:
generate the text prompt according the one or more selections satisfying a threshold of selection corresponding to the one or more vehicles.

20. The method of claim 15, comprising:
the text prompt having a first portion and a second portion, the first portion corresponding to first text indicative of at least one of the second appearance, the second motion, or the second sound of the object, and the second portion corresponding to second text indicative of at least one of the vehicle information, the drive mode, or the drive profile associated with the vehicle.

21. A method, comprising:
displaying, at a first user interface of a first system, an output that comprises at least one of an appearance, a motion, or a sound of an object;
displaying the output at a second user interface of a second system, in response to the detecting a trigger event that indicates a change in state of the second system.
